(19) United States
(12) Patent Application Publication
(10) Pub. No.: US 2022/0250276 A1
(43) Pub. Date: Aug. 11, 2022

(54) Extruder Device, Extruder System and Use of an Extruder Device and/or of an Extruder System

(71) Applicant: Putzmeister Engineering GmbH, Aichtal (DE)

(72) Inventors: Jens HAEFNER, Stuttgart (DE); Tobias HUTH, Stuttgart (DE); Knut KASTEN, Ostfildern (DE); Peter MOEGLE, Leinfelden (DE)

(21) Appl. No.: 17/593,771

(22) PCT Filed: Mar. 25, 2020
(86) PCT No.: PCT/EP2020/058297

§ 371 Date: Sep. 24, 2021

(30) Foreign Application Priority Data
Mar. 27, 2019 (DE) 10 2019 204 228.7

(51) Int. Cl. B28B 3/26; B28B 1/00; B28B 3/20; B33Y 30/00

(52) U.S. Cl. CPC B28B 3/2681; B28B 1/001; B33Y 30/00; B28B 3/205; B28B 3/2672

(57) ABSTRACT

An extruder apparatus for the extrusion of a strand of building material for 3D printing of a structural part includes an extruder nozzle and at least one cover element. The extruder nozzle has a discharge opening for the discharge of the strand of building material out of the extruder apparatus. The at least one cover element is designed to cover at least a part of the discharge opening such that an opening cross section of at least one uncovered part of the discharge opening specifies a strand cross section of the discharged strand of building material.

### FIELD OF APPLICATION AND PRIOR ART

The invention relates to an extruder apparatus for the extrusion of a strand of building material for 3D printing of a structural part, to an extruder system having such an extruder apparatus, and to the use of such an extruder apparatus and/or of such an extruder system.

### Problem and Solution

The problem addressed by the invention is that of providing an extruder apparatus for the extrusion of a strand of building material for 3D printing of a structural part, which extruder apparatus has improved characteristics, in particular allows more degrees of freedom. A further problem addressed by the invention is that of providing an extruder system having such an extruder apparatus and the use of such an extruder apparatus and/or of such an extruder system.

The invention solves this problem by providing an extruder apparatus, an extruder system, and the use of the extruder apparatus and system, in accordance with the independent claims. Advantageous refinements and/or configurations of the invention are described in the dependent claims.

The extruder apparatus according to the invention is designed or configured for the extrusion of a strand of building material for 3D printing of an in particular 3-dimensional structural part. The extruder apparatus has an extruder nozzle and at least one cover element. The extruder nozzle has a discharge opening for the discharge of the strand of building material out of the extruder apparatus, in particular the extruder nozzle. The in particular at least one cover element is designed or configured to cover, or covers, in particular at least and/or only part of the discharge opening, such that in particular only one opening cross section, in particular one area of the opening cross section, of in particular at least one uncovered part of the discharge opening specifies, in particular specifies the shape of, a strand cross section, in particular an area of the strand cross section, of the discharged or extruded strand of building material.

In particular, the extruder apparatus can be referred to as extruder head. Additionally or alternatively, the extruder apparatus, in particular the extruder nozzle, may be designed or configured for the extrusion or for the discharge of the strand of building material out of the extruder apparatus, in particular the extruder nozzle, in particular the discharge opening, in a non-vertical, in particular horizontal discharge direction. In other words: the extruder apparatus, in particular the extruder nozzle, does not need to be, or may not be, designed or configured for the extrusion or for the discharge of the strand of building material out of the extruder apparatus, in particular the extruder nozzle, in particular the discharge opening, in a vertical discharge direction. Further additionally or alternatively, the extruder apparatus may be designed to deposit the discharged strand such that the in particular deposited strand maintains its strand cross section, in particular of the discharged strand. In other words: the extruder apparatus does not need to be, or may not be, designed such that the building material needs to be, or can be, printed onto an already existing building material layer or ply and thus deformed.

The in particular discharged strand may be continuous or may extend over an in particular certain length.

The building material may be concrete, in particular fresh concrete, and/or thixotropic and/or set or dimensionally stable, in particular during the discharge. Further additionally or alternatively, the building material may have a maximum grain size of a minimum of 4 millimeters (mm), in particular of a minimum of 10 mm, in particular of a minimum of 16 mm.

3D printing can be referred to as additive manufacturing. Additionally or alternatively, the strand may be deposited or applied, in particular in layers, on or onto an already extruded strand, and/or a further strand may be deposited or applied, in particular in layers, on or onto the strand.

The structural part may be a building structural part and/or a wall and/or a ceiling. Additionally or alternatively, the strand, in particular a width of the strand, may have the thickness, in particular the entire thickness, of the wall and/or ceiling.

The extruder nozzle, in particular the discharge opening, may be tubular and/or peripherally closed, in particular in/counter to at least one peripheral direction which is orthogonal with respect to a discharge direction, in particular by at least one peripheral wall. Additionally or alternatively, the extruder nozzle may have the discharge opening at an in particular face-side and/or front end. Further additionally or alternatively, the discharge opening can be referred to as a dispensing opening or application opening. Further additionally or alternatively, the discharge opening may be planar or flat. Further additionally or alternatively, the discharge opening may have an in particular maximum opening width of a minimum of 100 mm, in particular a minimum of 200 mm, and/or a maximum of 800 mm, in particular a maximum of 600 mm, in particular 400 mm, in particular in a first peripheral direction which is orthogonal with respect to a discharge direction. Further additionally or alternatively, the discharge opening may have an in particular maximum opening height of a minimum of 15 mm, in particular a minimum of 25 mm, and/or a maximum of 400 mm, in particular a maximum of 200 mm, in particular a maximum of 100 mm, in particular 50 mm, in particular in a second peripheral direction which is orthogonal with respect to a discharge direction. Further additionally or alternatively, the discharge opening may have a quadrangular shape, in particular a trapezoidal shape, in particular a parallelogram shape, in particular a rectangular shape.

The cover element can be referred to as a screen or mask. Additionally or alternatively, the extruder apparatus may have two cover elements. Further additionally or alternatively, the at least one cover element may differ from the extruder nozzle. Further additionally or alternatively, the in particular at least one cover element may be planar or flat. Further additionally or alternatively, an in particular maximum ratio between the in particular at least one covered part and the in particular at least one uncovered part may be at least 0.05, in particular at least 0.1, in particular at least 0.2, in particular at least 0.5, in particular at least 1. In particular, the in particular at least one cover element may be designed to completely cover the discharge opening. Further additionally or alternatively, the in particular at least one covered part may have a quadrangular shape, in particular a trapezoidal shape, in particular a parallelogram shape, in particular a rectangular shape, and/or a circular segment shape, in particular a circular shape, and/or a triangular shape and/or a comb shape.

The strand cross section, in particular a shape and/or a size of the strand cross section, may correspond, in particular equate, to the opening cross section, in particular a shape and/or a size of the opening cross section. Additionally or alternatively, the opening cross section and/or the strand cross section may in particular each be non-parallel, in particular orthogonal, with respect to a discharge direction.

This, in particular the at least one cover element, allows the opening cross section that differs from the discharge opening and thus the strand cross section that differs from the discharge opening. In particular, this can allow the structural part to be printed with slots, holes, channels, in particular for lines or cables and/or pipes or for media such as electricity and/or water, or decorative surface elements. These therefore do not need to be produced, in particular in laborious fashion, if this is possible at all with reasonable effort, at a time after the printing, in particular by work operatives. The extruder apparatus thus has improved characteristics, in particular allows more degrees of freedom.

In a further development of the invention, the in particular at least one cover element is designed or configured or mounted to be in particular individually or separately, variably, in particular continuously, settable or adjustable, in particular movable, in particular into at least two different settings, for the purposes of variably, in particular continuously, settably and/or adjustably covering the discharge opening for the purposes of variably, in particular continuously, setting or adjusting the opening cross section for the purposes of variably, in particular continuously, setting or adjusting the strand cross section, in particular during the discharge of the strand of building material. This makes it possible, in particular, to realize different geometrical characteristics and/or modifications in the printed structural part, in particular different wall and/or ceiling thicknesses. In particular, this can make it possible for a transition, in particular between two wall thicknesses, to be configured without a shoulder. In particular, the in particular at least one cover element may be designed to be variably settable without the use of tools.

In one embodiment of the invention, the in particular at least one cover element is designed or configured to be variably settable for the purposes of separating off, in particular cutting off, the discharged strand of building material from the extruder apparatus, in particular from the extruder nozzle, in particular at the discharge opening. This can allow an in particular clean or smooth end of the in particular discharged and/or deposited strand, in particular at a time after the extrusion, in particular during the transposition of the extruder apparatus, in particular between different wall elements. Additionally or alternatively, the in particular at least one cover element may be designed to move along the discharge opening for separating-off purposes.

In one refinement of the invention, the in particular at least one cover element is designed or configured for in particular variably settable arrangement on the discharge opening, in particular so as to be in contact with the extruder nozzle. This makes it possible to reduce or even avoid an unintended escape of building material out of the extruder apparatus, in particular the extruder nozzle, at an unintended location and/or in/counter to the first peripheral direction and/or the second peripheral direction.

In one refinement of the invention, the extruder nozzle specifies an in particular non-vertical, in particular horizontal, discharge direction of the strand of building material out of the extruder apparatus, in particular the extruder nozzle, in particular the discharge opening. The in particular at least one cover element has in particular at least one cover surface for partially covering the discharge opening. The in particular at least one cover surface is designed or configured or is oriented for non-parallel, in particular orthogonal orientation with respect to the discharge direction. This allows building material to be blocked in the extruder nozzle behind the in particular at least one cover element as viewed oppositely with respect to the discharge direction. In particular, the discharge direction may be parallel, in particular coaxial, with respect to a longitudinal axis of the extruder nozzle. Additionally or alternatively, the in particular at least one cover surface may be planar or flat.

In one refinement of the invention, the extruder nozzle has multiple peripheral walls. The peripheral walls peripherally define or delimit the discharge opening. Furthermore, in particular at least two of the peripheral walls are designed or configured or mounted to be variably, in particular continuously, settable or adjustable, in particular movable, in particular into at least two different settings, for the purposes of variable, in particular continuous, arrangement with respect to one another for the purposes of variably, in particular continuously setting or adjusting the discharge opening, in particular during the discharge of the strand of building material. This allows additional degrees of freedom, in particular in terms of the shaping of the opening cross section and thus in particular the shaping of the strand cross section. In particular, at least one of the peripheral walls may be planar or flat and/or a metal sheet. Additionally or alternatively, at least one of the in particular settable peripheral walls may be movable relative to the other peripheral walls and/or the in particular at least one cover element, in particular in/counter to the first peripheral direction and/or the second peripheral direction. Further additionally or alternatively, at least one of the in particular settable peripheral walls may be designed to be variably settable without the use of tools.

In one refinement of the invention, the extruder nozzle has in particular the at least one peripheral wall. An extent of the extruder apparatus in an in particular vertical direction, in particular counter to the second peripheral direction, in particular downward, is defined or delimited by the peripheral wall. The discharge opening is peripherally defined or delimited, in particular at least partially, in particular in the direction, in particular downward, by the peripheral wall.

Additionally or alternatively, an extent of the extruder apparatus is defined or delimited in an in particular horizontal direction, in particular in the discharge direction, in particular towards the front, by the in particular at least one cover element.

Additionally or alternatively, the extruder apparatus has a deflecting device or a deflecting element. The deflecting device is arranged upstream of the discharge opening, in particular of the extruder nozzle, and is designed or configured to deflect a flow of building material in particular from a non-horizontal, in particular vertical direction, in particular counter to the second peripheral direction, in particular from top to bottom, in the direction, in particular in the discharge direction, in particular from rear to front, of the discharge opening.

This, in particular the extent defined by the peripheral wall, allows the strand to be extruded, in particular in the horizontal discharge direction, at a relatively short distance in particular vertically above an already extruded strand, in particular without damaging the latter, and thus allows the discharged strand to be deposited from a relatively low height.

This, in particular the extent defined by the in particular at least one cover element, allows an in particular clean or smooth separating-off action and/or an in particular clean depositing of the discharged strand and/or an in particular clean or smooth connection of the strand to an already extruded strand, in particular without damaging the latter.

This, in particular the deflecting device, allows the horizontal discharge.

In particular, the at least one peripheral wall may be planar or flat and/or a metal sheet.

In one refinement of the invention, the in particular at least one cover element is designed or configured to cover the, in particular at least one, part of the discharge opening such that the opening cross section is at least divided into two parts with an interruption, in particular in an in particular horizontal direction, in particular in the first peripheral direction. In other words: at least two parts of the discharge opening, which are in particular separated from one another by the in particular at least one cover element, may be uncovered. This allows channels to be generated in the interior of the structural part, in particular of the wall, such that lines can be laid in a concealed manner. In particular, the interruption may extend over the full, in particular maximum, opening height.

The extruder system according to the invention is designed or configured for the extrusion of a, in particular the, strand of building material for 3D printing of a, in particular the, structural part. The extruder system has one, in particular the, extruder apparatus as described above.

In addition, the extruder system according to the invention has an in particular controllable movement apparatus. The movement apparatus is designed or configured for in particular automatically at least translationally moving the extruder apparatus, in particular the extruder nozzle, and the in particular at least one cover element, in particular during the discharge of the strand of building material. In particular, the movement apparatus can be referred to as positioning apparatus. Additionally or alternatively, the movement apparatus may have or be a movement or robot arm or a mast. Additionally or alternatively, the movement apparatus and/or the extruder apparatus may be designed for in particular automatically rotationally moving the extruder apparatus, in particular the extruder nozzle and the in particular at least one cover element, in particular during the discharge of the strand of building material.

In one refinement of the invention, the movement apparatus is designed or configured to move the extruder apparatus in an in particular non-vertical, in particular horizontal movement direction. The extruder apparatus is designed or configured for the discharge of the strand of building material out of the extruder apparatus, in particular the extruder nozzle, in particular the discharge opening, in a discharge direction, which is non-orthogonal, in particular reversed, in particular opposite, with respect to the movement direction, in particular during the movement.

Additionally or alternatively, the extruder system, in particular the extruder apparatus, is designed or configured for the discharge of the strand of building material out of the extruder apparatus, in particular the extruder nozzle, in particular the discharge opening, with an in particular variable in particular continuously settable or adjustable discharge speed. The movement apparatus is designed or configured to move the extruder apparatus at a movement speed approximately equal to the discharge speed, in particular during the discharge.

This, in particular the approximately equal movement speeds, makes it possible for the discharged and/or deposited strand to maintain its strand cross section which in particular corresponds, in particular equates, to the opening cross section.

In particular, reversed can mean a minimum of 135 degrees (°), in particular a minimum of 150°, in particular 165°. Additionally or alternatively, opposite can mean 180°. Further additionally or alternatively, approximately can mean a difference or a deviation of at most 5 percent (%), in particular of at most 2%, in particular of at most 1%.

Additionally or alternatively, the extruder system according to the invention has an in particular controllable building material pump. The building material pump is designed or configured to in particular automatically convey building material out of the extruder apparatus, in particular the extruder nozzle, in particular the discharge opening. In particular, the extruder system may comprise a building material conveying line, wherein the building material conveying line may connect the building material pump to the extruder apparatus, in particular the extruder nozzle, for a flow of building material from the building material pump through the building material conveying line to the extruder apparatus, in particular the extruder nozzle. Additionally or alternatively, the building material pump may be discontinuous, in particular a piston pump, in particular a two-piston pump, in particular having a pipe switch.

Additionally or alternatively, the extruder system according to the invention has in particular at least one in particular controllable and/or electrical setting apparatus or adjusting apparatus. The in particular at least one setting apparatus is designed or configured for the in particular automatic, variable, in particular continuous setting or adjustment of the in particular at least one and/or variably settably designed cover element and/or the in particular at least one and/or variably settably designed peripheral wall. In particular, the extruder apparatus may have the in particular at least one setting apparatus. Additionally or alternatively, the in particular at least one separating apparatus may have or be at least one in particular electrical and/or hydraulic and/or pneumatic setting motor and/or at least one in particular mechanical setting drive.

Additionally or alternatively, the extruder system according to the invention has an in particular controllable and/or electrical vibrating apparatus. The vibrating apparatus is designed or configured for in particular automatically vibrating or stimulating the in particular at least one cover element. This makes it possible to loosen or displace stones in the concrete, in particular behind the in particular at least one cover element, and thus to reduce or even avoid the risk of blocking by stones in the concrete, in particular behind the in particular at least one cover element, in particular for separating-off purposes. In particular, the extruder apparatus may have the vibrating apparatus. Additionally or alternatively, the vibrating apparatus may have or be an eccentric and/or an ultrasound source. Further additionally or alternatively, the vibrating apparatus may differ from the in particular at least one setting apparatus.

In one refinement of the invention, the extruder system comprises an in particular electrical control device, in particular a computer. The control device is designed or configured to in particular automatically and/or independently control the in particular controllable movement apparatus and/or the in particular controllable building material pump and/or the in particular at least one in particular controllable setting apparatus and/or the in particular controllable vibrating apparatus in a manner dependent on data, in particular a building or construction plan, in particular in a memory of the control device, of the structural part to be printed. This makes it possible that a work operative does not need to control the extruder system, and/or that errors during the construction process can be reduced or even avoided.

Furthermore, the invention relates to the use of an, in particular the, extruder apparatus and/or of an, in particular the, extruder system as described above for the extrusion of a, in particular the, strand of building material for 3D printing of a, in particular the, structural part.

### BRIEF DESCRIPTION OF THE DRAWINGS

Further advantages and aspects of the invention will emerge from the claims and from the following description of preferred exemplary embodiments of the invention, which are discussed below with reference to the figures.

FIG. 1 shows a perspective view of an extruder system according to the invention with an extruder apparatus according to the invention.

FIG. 2 shows a further perspective view of the extruder system with the extruder apparatus of FIG. 1.

FIG. 3 shows a front view of the extruder system with the extruder apparatus of FIG. 1 with at least one cover element in a first setting and at least one peripheral wall in a first setting.

FIG. 4 shows a side view of the extruder system with the extruder apparatus of FIG. 3.

FIG. 5 shows a front view of the extruder system with the extruder apparatus of FIG. 1 with the at least one cover element in a second setting and the at least one peripheral wall in a second setting.

FIG. 6 shows a perspective view of the extruder system with the extruder apparatus of FIG. 5.

FIG. 7 shows a front view of the extruder system with the extruder apparatus of FIG. 1 with the at least one cover element in a third setting and the at least one peripheral wall in the second setting.

FIG. 8 shows a side view of the extruder system with the extruder apparatus of FIG. 7.

FIG. 9 shows a perspective view of the extruder system with the extruder apparatus of FIG. 1 without a cover element, without an upper peripheral wall and without a hose.

FIG. 10 shows a perspective view of the extruder system with the extruder apparatus of FIG. 1 without a cover element and with a pivoted-open upper peripheral wall and a pivoted-open lower peripheral wall and with a hose.

FIG. 11 shows a perspective view of the extruder system with the extruder apparatus of FIG. 1 and a movement apparatus.

FIG. 12 shows a perspective view of the extruder system with the extruder apparatus of FIG. 1 and a building material pump, in particular during use according to the invention.

FIGS. 13-16 show structural parts 3D-printed using an extruder apparatus according to the invention and/or an extruder system according to the invention and composed of extruded strands of building material.

FIG. 17 shows a perspective view of a further extruder system according to the invention with a further extruder apparatus according to the invention.

FIG. 18 shows a side view of the extruder system with the extruder apparatus of FIG. 17.

FIG. 19 shows a perspective view of a yet further extruder system according to the invention with a yet further extruder apparatus according to the invention.

### DETAILED DESCRIPTION OF THE EXEMPLARY EMBODIMENTS

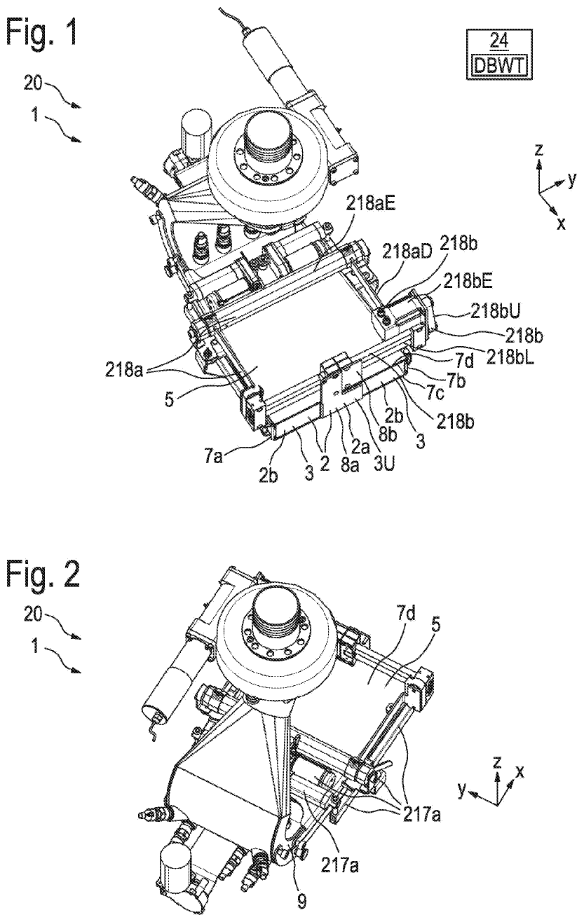

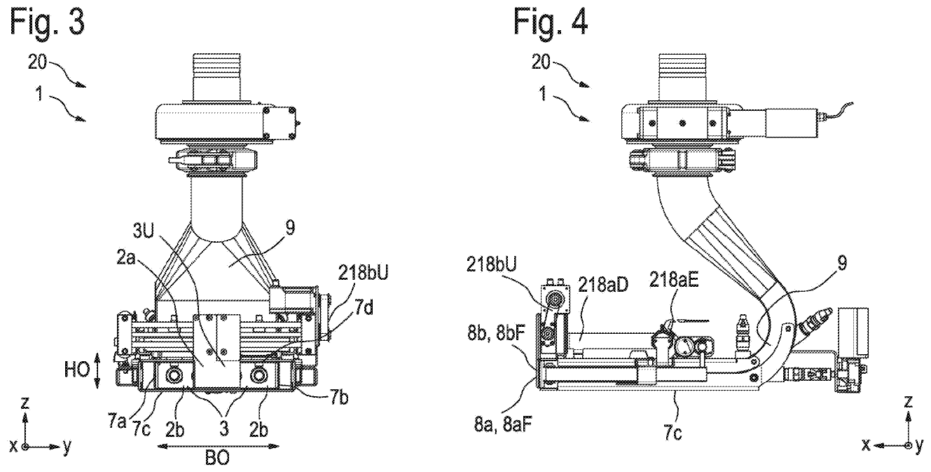

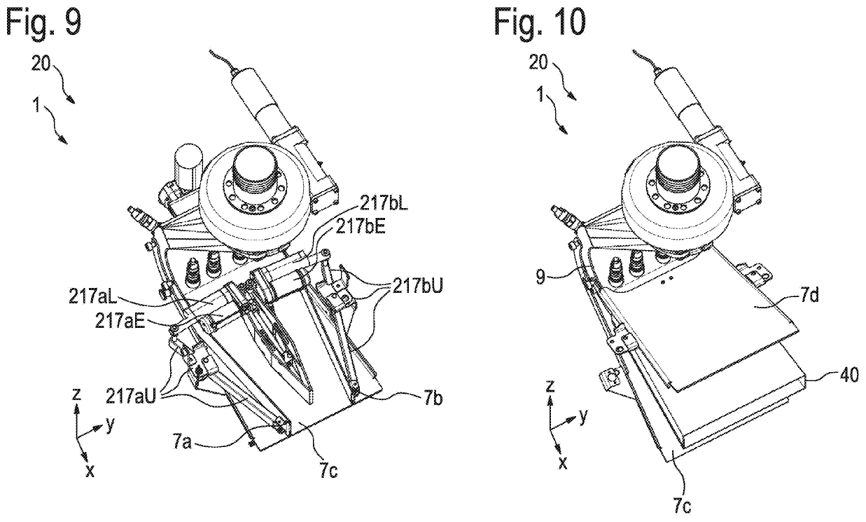

FIGS. 1 to 12 and 17 to 19 in particular each show an extruder system 20 having an extruder apparatus 1 for extrusion of a strand ST of building material BS for 3D printing of a structural part BWT. The extruder apparatus 1 has an extruder nozzle 5 and at least one cover element 8, 8a, 8b. The extruder nozzle 5 has an in particular rectangular discharge opening 2 for the discharge of the strand ST of building material BS out of the extruder apparatus 1. The in particular at least one cover element 8, 8a, 8b is designed to cover at least a part 2a of the discharge opening 2 such that an opening cross section 3 of at least one uncovered part 2b of the discharge opening 2 specifies a strand cross section 4 of the discharged strand ST of building material BS.

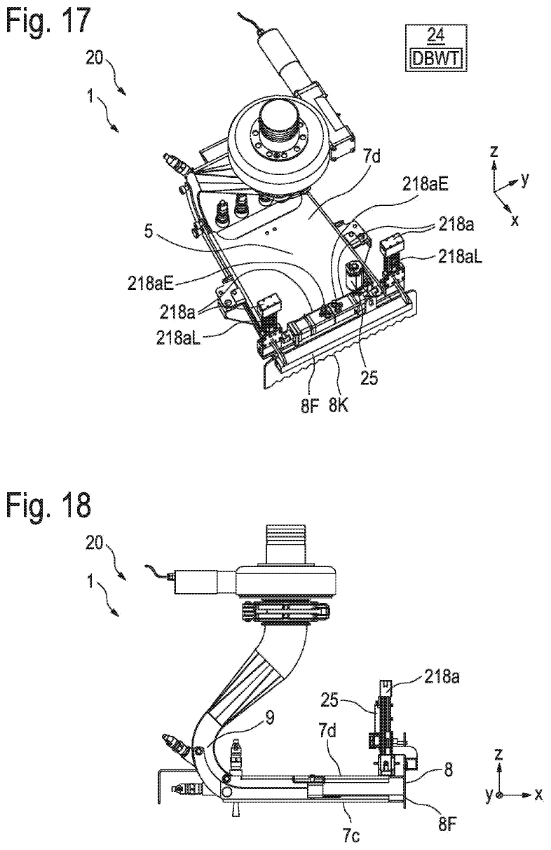

In the exemplary embodiment shown in FIGS. 1 to 8, the extruder apparatus 1 has in particular exactly two in particular rectangular cover elements 8a, 8b. In the exemplary embodiment shown in FIGS. 17 and 18, the extruder apparatus 1 has in particular exactly one in particular rectangular cover element 8. In alternative exemplary embodiments, the extruder apparatus may have at least three cover elements.

In the exemplary embodiments shown, the at least one cover element 8, 8a, 8b has a variably settable design, in particular is movable, in particular in/counter to a first peripheral direction y and/or second peripheral direction z, in particular relative to the discharge opening 2 or the extruder nozzle 5, for the variably settable covering of the discharge opening 2 for the variably setting of the opening cross section 3 for the variable setting of the strand cross section 4, in particular during the discharge of the strand ST of building material BS.

In detail, the at least one cover element 8, 8a, 8b is designed to be variably settable for the purposes of separating off, in particular cutting off, the discharged strand ST of building material BS from the extruder apparatus 1, in particular at the discharge opening 2.

In the exemplary embodiments shown, the at least one cover element 8, 8a, 8b has a cutting plate or a blade 8K, 8aK, 8bK.

Furthermore, in the exemplary embodiment shown in FIGS. 1 to 8, the at least one cover element 8a, 8b is designed to cover the at least one part 2a of the discharge opening 2 such that the opening cross section 3 is at least divided into two parts with an interruption 3U, in particular in an in particular horizontal direction, in particular in the first peripheral direction y.

Furthermore, in the exemplary embodiments shown, the at least one cover element 8, 8a, 8b is designed for in particular variably settable arrangement on the discharge opening 2, in particular so as to be in contact with the extruder nozzle 5.

In a first setting shown in FIGS. 1 to 4, the two cover elements 8a, 8b are arranged on the discharge opening 2 and cover an in particular inner and/or rectangular part 2a of the discharge opening 2 such that the opening cross section 3 is in particular rectangular and is divided into two parts with an in particular rectangular interruption 3U, in particular in the first peripheral direction y. In other words: two parts 2b of the discharge opening 2, which are in particular outer parts and/or parts separated from one another by the two cover elements 8a, 8b, are uncovered. In detail, the cover elements 8a, 8b overlap or are pushed one over the other in a discharge direction x. The two-part, in particular rectangular opening cross section 3 with the in particular rectangular interruption 3U thus specifies the two-part, in particular rectangular, strand cross section 4 with an in particular rectangular interruption 4U of the discharged strand ST of building material BS.

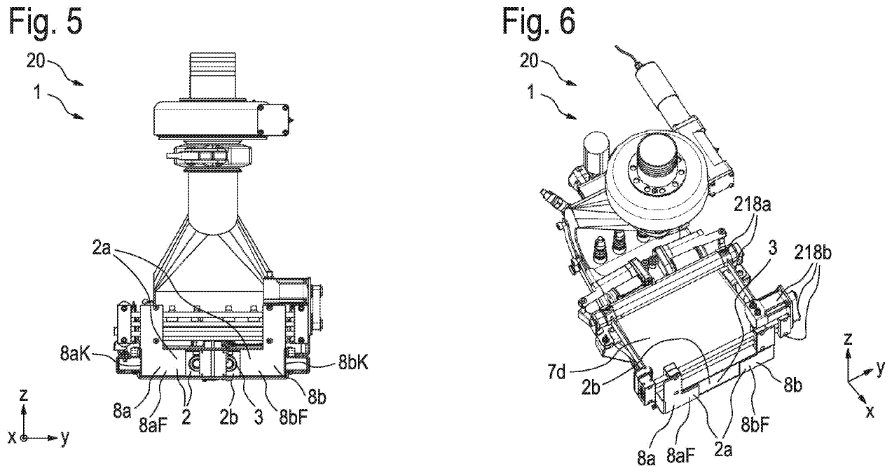

In a second setting which is shown in FIGS. 5 and 6 and which in particular differs from the first, the two cover elements 8a, 8b are arranged on the discharge opening 2 and cover two in particular outer and/or rectangular parts 2a of the discharge opening 2 such that the opening cross section 3 is in particular rectangular and narrow, in particular in the first peripheral direction y. In other words: an in particular inner part 2b of the discharge opening 2 is uncovered. The narrow, in particular rectangular opening cross section 3 thus specifies the narrow, in particular rectangular strand cross section 4 of the discharged strand ST of building material BS. Additionally or alternatively, by movement from/to the setting shown in FIGS. 1 to 4 to/from the setting shown in FIGS. 5 and 6 of the two cover elements 8a, 8b, in particular in/counter to the first peripheral direction y, the discharged strand ST of building material BS is separated off from the extruder apparatus 1.

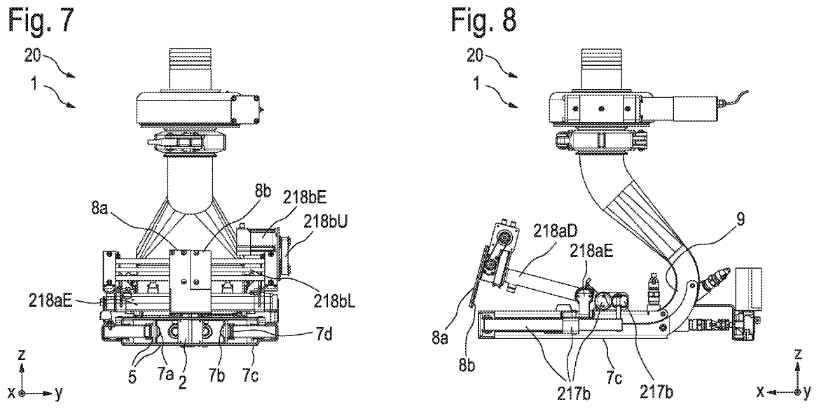

In a third setting which is shown in FIGS. 7 and 8 and which in particular differs from the first and second, the two cover elements 8a, 8b are not arranged on the discharge opening 2 and do not cover any part of the discharge opening 2, or the discharge opening 2 is uncovered. In other words: the two cover elements 8a, 8b have been lifted off in the second peripheral direction z. The in particular rectangular discharge opening 2 thus specifies the strand cross section 4 of the discharged strand ST of building material BS.

In a setting shown in FIGS. 17 and 18, the cover element 8 is arranged on the discharge opening 2 and completely covers the discharge opening 2. In particular, by movement from a setting in which the cover element 8 is not arranged on the discharge opening 2 and does not cover any part of the discharge opening 2, or in which the cover element 8 has been lifted off in the second peripheral direction z, to the setting shown in FIGS. 17 and 18, in particular counter to the second peripheral direction −z, the discharged strand ST of building material BS is separated off from the extruder apparatus 1.

The extruder nozzle 5 furthermore specifies an in particular horizontal discharge direction x of the strand ST of building material BS out of the extruder apparatus 1. The at least one cover element 8, 8a, 8b has at least one cover surface 8F, 8aF, 8bF for partially covering the discharge opening 2. The at least one cover surface 8F, 8aF, 8bF is designed to be oriented non-parallel, in particular orthogonally, with respect to the discharge direction x.

In addition, the extruder nozzle 5 has multiple peripheral walls 7a, 7b, 7c, 7d, four in the exemplary embodiments shown. The peripheral walls 7a, 7b, 7c, 7d peripherally define the discharge opening 2. Furthermore, at least two, in the exemplary embodiments shown exactly two, of the peripheral walls 7a, 7b are designed to be variably settable for the purposes of variable arrangement with respect to one another for the purposes of variable setting of the discharge opening 2, in particular during the discharge of the strand ST of building material BS.

In the exemplary embodiments shown, a left-hand peripheral wall 7a and a right-hand peripheral wall 7b are in particular each designed to be variably settable, in particular movable in/counter to the first peripheral direction y, for the purposes of variably setting an opening width BO of the discharge opening 2. Additionally or alternatively, in alternative exemplary embodiments, a lower peripheral wall and/or an upper peripheral wall may in particular each be designed to be variably settable, in particular in/counter to the second peripheral direction, for the purposes of variably setting an opening height of the discharge opening.

In a first setting shown in FIGS. 1 to 4, the two peripheral walls 7a, 7b are in particular each arranged as far to the outside as possible, or with a maximum spacing to one another, such that the opening width BO of the discharge opening 2 is set to a maximum or to be wide, in the exemplary embodiments shown 400 mm.

In a second setting shown in FIGS. 5 to 8, which in particular differs from the first setting, the two peripheral walls 7a, 7b are in particular each arranged as far to the inside as possible, or with a minimum spacing to one another, or so as to be as close together as possible, such that the opening width BO of the discharge opening 2 is set to a minimum or to be narrow, in the exemplary embodiments shown 200 mm.

In the embodiments shown, an opening height HO of the discharge opening 2 is 50 mm, in particular in the second peripheral direction z.

In detail, the extruder apparatus 1 has a hose 40 that is expandable, in particular by approximately a factor of 2, wherein the expandable hose 40 is arranged and designed to seal off the peripheral walls 7a, 7b, 7c, 7d against a peripheral discharge of building material BS, as shown in FIG. 10.

Additionally or alternatively, at least one of the peripheral walls 7c, 7d is designed for being peripherally pivoted open, in particular in/counter to the second peripheral direction z, as shown in FIG. 10. This, in particular the pivoting open, allows easy installation of the expandable hose 40 and easy cleaning of the extruder system 20, in particular of the extruder apparatus 1, after the extrusion process, in particular after the concreting process.

Furthermore, an extent of the extruder apparatus 1 in an in particular vertical direction, in particular counter to the second peripheral direction −z, is defined by the in particular lower peripheral wall 7c. The discharge opening 2 is peripherally defined partially, in particular in the direction −z, by the in particular lower peripheral wall 7c.

Additionally or alternatively, an extent of the extruder apparatus 1 in an in particular horizontal direction, in particular in the discharge direction x, is defined by the at least one cover element 8, 8a, 8b.

Additionally or alternatively, the extruder apparatus has a deflecting device 9. The deflecting device 9 is arranged upstream of the discharge opening 2 and is designed to deflect a flow of building material BS, in particular from a pipe flange, in the direction, in particular in the discharge direction x, of the discharge opening 2.

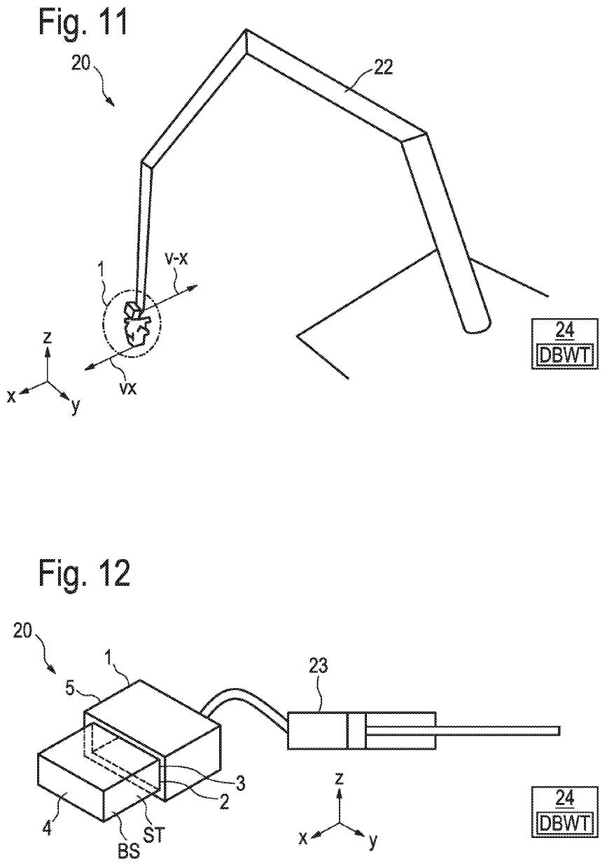

Furthermore, the extruder system 20 has an in particular controllable movement apparatus 22, as shown in FIG. 11. The movement apparatus 22 is designed to at least translationally move the extruder apparatus 1, in particular during the discharge of the strand ST of building material BS.

In the exemplary embodiments shown, the movement apparatus 22 has a movement arm. Additionally or alternatively, the movement apparatus 22 and/or the extruder apparatus 1 are/is designed to move the extruder apparatus 1 in rotation, in particular during the discharge of the strand ST of building material BS. In detail, the extruder apparatus 1 is rotatable about a longitudinal axis of the pipe flange by means of an in particular electric motor and in particular a screw drive.

In detail, the movement device 22 is designed to move the extruder apparatus 1 in an in particular horizontal movement direction −x. The extruder apparatus 1 is designed for the discharge of the strand ST of building material BS out of the extruder apparatus 1 in the discharge direction x which is non-orthogonal, in particular opposite, to the movement direction −x, in particular during the movement.

Additionally or alternatively, the extruder system 20, in particular the extruder apparatus 1, is designed for the discharge of the strand ST of building material BS out of the extruder apparatus 1 with an in particular variably settable discharge speed vx. The movement apparatus 22 is designed to move the extruder apparatus 1 at a movement speed v-x approximately equal to the discharge speed vx, in particular during the discharge.

Furthermore, the extruder system 20 has an in particular controllable building material pump 23, as shown in FIG. 12. The building-material pump 23 is designed to convey building material BS out of the extruder apparatus 1.

In the exemplary embodiments shown, the building material pump is discontinuous, in particular a piston pump. Additionally or alternatively, the extruder system 20 has a building material conveying line, wherein the building material conveying line connects the building material pump 23 to the extruder apparatus 1 for a stream of building material BS from the building material pump 23 through the building material conveying line to the extruder apparatus 1.

In addition, the extruder system 20 has at least one in particular controllable setting apparatus 217a, 217b, 218a, 218b. The at least one setting device 217a, 217b, 218a, 218b is designed for the variable setting of the at least one in particular variably settable cover element 8, 8a, 8b and/or of the at least one in particular variably settable peripheral wall 7a, 7b.

In the exemplary embodiments shown, the extruder apparatus 1 has the at least one setting apparatus 217a, 217b, 218a, 218b.

In detail, in FIGS. 1 to 8, the setting apparatus 218a for moving the at least one cover element 8a, 8b in/counter to the second peripheral direction z has an in particular electrical setting motor 218aE and/or an in particular mechanical rotary drive 218aD. The setting motor 218aE is arranged in the second peripheral direction z above the extruder nozzle 5 or the peripheral wall 7d and/or is connected in terms of movement to the at least one cover element 8a, 8b by means of the rotary drive 218aD.

Furthermore, in FIGS. 1 to 8, the setting apparatus 218b for moving the at least one cover element 8a, 8b in/counter to the second extent direction y has an in particular electrical setting motor 218bE and/or a movement deflecting mechanism 218bU, in particular a belt mechanism, and/or an in particular mechanical linear drive 218bL, in particular a threaded spindle drive. The setting motor 218bE is arranged in the second peripheral direction z above the extruder nozzle 5 or the peripheral wall 7d and/or is connected in terms of movement to the at least one cover element 8a, 8b by means of the movement deflecting mechanism 218bU and/or the linear drive 218bL.

In the exemplary embodiment shown in FIGS. 1 to 8, the two cover elements 8a, 8b are not designed to be mutually distinctly or individually or separately variably settable. In alternative exemplary embodiments, the two cover elements may in particular in each case be designed to be individually variably settable.

Furthermore, in FIGS. 17 and 18, the setting apparatus 218a for moving the cover element 8 in/counter to the second peripheral direction z has at least one in particular electrical setting motor 218aE and/or at least one in particular mechanical linear drive 218aL, in particular at least one threaded spindle drive. The at least one setting motor 218aE is arranged in the second peripheral direction z above the extruder nozzle 5 or the peripheral wall 7d and/or is connected in terms of movement to the cover element 8 by means of the at least one linear drive 218aL.

Furthermore, in FIGS. 1 to 9, the at least one setting apparatus 217a, 217b for moving the at least one peripheral wall 7a, 7b in/counter to the first peripheral direction y has at least one in particular electrical setting motor 217aE, 217bE and/or at least one movement deflecting mechanism 217aU, 217bU, in particular a lever mechanism, and/or at least one in particular mechanical linear drive 217aL, 217bL, in particular at least one threaded spindle drive. The at least one setting motor 217aE, 217bE is arranged, in particular transversely, in the second peripheral direction z above the extruder nozzle 5 or the peripheral wall 7d and/or is connected in terms of movement to the at least one peripheral wall 7a, 7b by means of the at least one movement deflecting mechanism 217aU, 217bU and/or the at least one linear drive 217aL, 217bL.

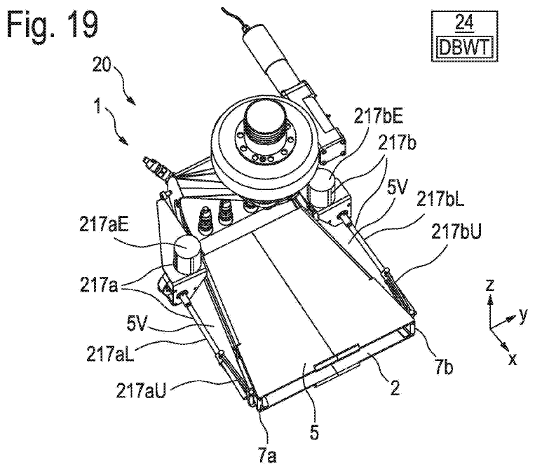

In addition, in FIG. 19, the at least one setting apparatus 217a, 217b for moving the at least one peripheral wall 7a, 7b in/counter to the first peripheral direction y has at least one in particular electrical setting motor 217aE, 217bE and/or at least one movement deflecting mechanism 217aU, 217bU, in particular a lever mechanism, and/or at least one in particular mechanical linear drive 217aL, 217bL, in particular at least one threaded spindle drive. The at least one setting motor 217aE, 217bE is arranged, in particular longitudinally, in/counter to the first peripheral direction y to the side of the extruder nozzle 5 or the at least one peripheral wall 7a, 7b and/or is connected in terms of movement to the at least one peripheral wall 7a, 7b by means of the at least one movement deflecting mechanism 217aU, 217bU and/or the at least one linear drive 217aL, 217bL. In particular, the extruder nozzle 5 has, proceeding from the discharge opening 2 in the case of maximum opening width BO, counter to the discharge direction −x, a taper 5V in/counter to the first peripheral direction y, wherein the at least one setting motor 217aE, 217bE is arranged to the side of the extruder nozzle 5 at the taper 5V.

In the exemplary embodiment shown in particular in each case in FIGS. 1 to 9 and 19, the two peripheral walls 7a, 7b are in particular in each case designed to be mutually distinctly or individually or separately variably settable. In alternative exemplary embodiments, the two peripheral walls may be designed not to be mutually distinctly variably settable.

Furthermore, the extruder system 20 has an in particular controllable vibrating apparatus 25, as shown in FIGS. 17 and 18. The vibrating apparatus 25 is designed to vibrate the cover element 8.

In the exemplary embodiment shown, the extruder apparatus 1 has the vibrating apparatus 25. Additionally or alternatively, the vibrating apparatus 25 is an eccentric.

Furthermore, the extruder system 20, in particular the extruder apparatus 1, has a number of in particular controllable injection nozzles, in particular cyclically operated high-pressure nozzles with a pressure greater than 10 bar, in particular greater than 100 bar. The injection nozzles are designed for injecting, in particular for admixing or introducing, an additive, in particular concrete accelerator, in particular directly into the building material BS before it is discharged. This, in particular the high pressure, allows the additive to be widely distributed such that no further mixing element is required. In detail, the number of injection nozzles is arranged above the extruder nozzle 5 or the peripheral wall 7d in the second peripheral direction z and/or behind the extruder nozzle 5, and in particular the deflecting device 9, counter to the discharge direction −x. This, in particular the arrangement, makes it possible that, in pumping intervals or interruptions in the printing process, the smallest possible amount of activated building material, in particular concrete, is present in the extruder system 20, in particular the extruder apparatus 1, and/or has to be disposed of.

The extruder system 20 furthermore has a control device 24. The control device 24 is designed to in particular automatically control the in particular controllable movement apparatus 22 and/or the in particular controllable building material pump 23 and/or the at least one in particular controllable setting apparatus 217a, 217b, 218a, 218b and/or the in particular controllable vibrating apparatus 25, and in particular the number of in particular controllable injection nozzles, in a manner dependent on data DBWT of the structural part BWT to be printed.

In addition, the extruder system 20, in particular the extruder apparatus 1, is designed to deposit the discharged strand ST such that the in particular deposited strand ST maintains its strand cross section 4, in particular of the discharged strand ST.

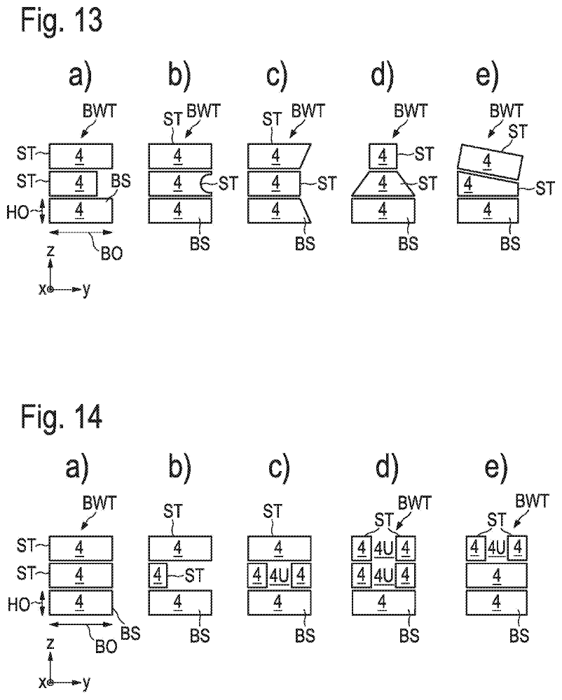

Furthermore, the strand ST may be deposited, in particular in layers, on an already extruded strand ST and/or a further strand ST may be deposited, in particular in layers, on the strand ST, as shown in FIGS. 13 to 16.

In particular, FIGS. 12 to 16 show the use of the extruder apparatus 1 and/or of the extruder system 20 for the extrusion of the strand ST of building material BS for 3D printing of the structural part BWT, and structural parts BWT 3D-printed by means of the extruder apparatus 1 and/or the extruder system 20 and composed of extruded strands ST of building material BS.

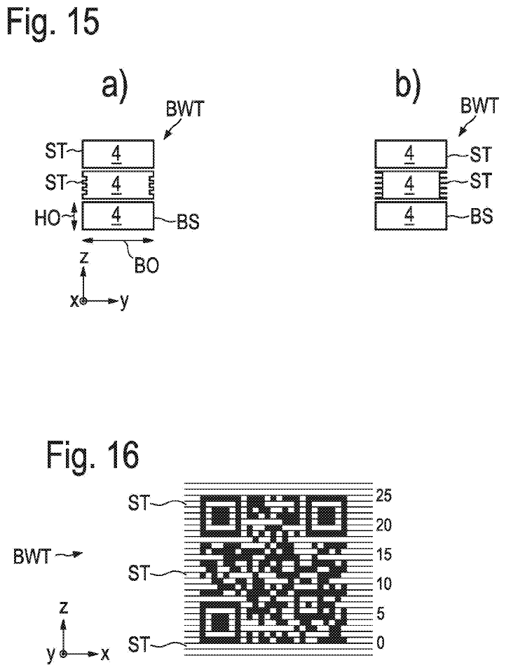

In detail, the rectangular strand cross section 4 shown in particular in each case in FIG. 13 a) at the bottom and top, b) at the bottom and top, d) at the bottom and e) at the bottom and top, FIG. 14 a), b) at the bottom and top, c) at the bottom and top, d) at the bottom and e) at the bottom and in the middle and FIG. 15 a) at the bottom and top and b) at the bottom and top may be specified or is specified by the at least one cover element 8, 8a, 8b not arranged on the rectangular discharge opening 2 or not covering any part of the rectangular discharge opening 2 and by the in particular uncovered rectangular discharge opening 2 with the peripheral walls 7a, 7b in particular in each case situated as far to the outside as possible or with maximum opening width BO.

The rectangular strand cross section 4 shown in particular in each case in FIG. 13 a) in the middle and c) in the middle may be specified or is specified by the at least one cover element 8, 8a, 8b not arranged on the rectangular discharge opening 2 or not covering any part of the rectangular discharge opening 2 and by the in particular uncovered rectangular discharge opening 2 with the peripheral wall 7a situated as far to the outside or to the left as possible and the peripheral wall 7b situated as far to the inside or to the left as possible or by a rectangular cover element covering a right-hand or outer part 2a of the rectangular discharge opening 2 with maximum opening width BO.

The rectangular strand cross section 4 shown in FIG. 13 d) at the top may be specified or is specified by the at least one cover element 8, 8a, 8b not arranged on the rectangular discharge opening 2 or not covering any part of the rectangular discharge opening 2 and by the in particular uncovered rectangular discharge opening 2 with the peripheral walls 7a, 7b in particular in each case situated as far to the inside as possible or by rectangular cover elements covering a right-hand part 2a and a left-hand part 2a or outer parts 2a of the rectangular discharge opening 2 with maximum opening width BO.

The rectangular strand cross section 4 shown in FIG. 13 b) in the middle with a semicircular cutout may be specified or is specified by a semicircular cover element covering a right-hand part 2a of the rectangular discharge opening 2 with maximum opening width BO.

The rectangular strand cross section 4 shown in particular in each case in FIG. 13 c) at the bottom and top with a trapezoidal or triangular cutout may be specified or is specified by an in particular respective trapezoidal or triangular cover element covering a right-hand or outer part 2a of the rectangular discharge opening 2 with maximum opening width BO.

The rectangular strand cross section 4 shown in FIG. 13 d) in the middle with trapezoidal or triangular cutouts may be specified or is specified by trapezoidal or triangular cover elements covering a right-hand part 2a and a left-hand part 2a or outer parts 2a of the rectangular discharge opening 2 with maximum opening width BO.

The rectangular strand cross section 4 shown in FIG. 13 e) in the middle with a trapezoidal or triangular cutout may be specified or is specified by a trapezoidal or triangular cover element covering an upper or outer part 2a of the rectangular discharge opening 2 with maximum opening width BO.

The rectangular two-part strand cross section 4 shown in particular in each case in FIG. 14 c) in the middle, d) at the bottom and top and e) at the top with a rectangular interruption 4U may be specified or is specified by at least one rectangular cover element covering a middle or inner part 2a of the rectangular discharge opening 2 with maximum opening width BO.

The rectangular strand cross section 4 shown in FIG. 14 b) in the middle may be specified or is specified by at least one rectangular cover element covering a right-hand or outer part 2a and a middle or inner part 2a of the rectangular discharge opening 2 with maximum opening width BO or by at least one rectangular cover element covering a middle or inner part 2a of the rectangular discharge opening 2 with the peripheral wall 7a situated as far to the outside or to the left as possible and the peripheral wall 7b situated as far to the inside or to the left as possible.

The rectangular strand cross section 4 shown in particular in each case in FIG. 15 a) in the middle and b) in the middle with comb-like cutouts may be specified or is specified by in particular respective comb-like cover elements covering a right-hand part 2a and a left-hand part 2a of the rectangular discharge opening 2 with maximum opening width BO.

Thus, a transition between two thicknesses of a structural part or of a wall BWT can be configured without shoulders, as shown in FIGS. 13 c) and d).

Additionally or alternatively, a non-vertical or non-perpendicular structural part or a non-vertical wall BWT with a transition to a vertical or perpendicular section can be produced, as shown in FIG. 13 e).

Additionally or alternatively, a strand or a layer or a ply ST of a structural part or a wall BWT can be made narrower, in particular in order to create a horizontal channel for an electrical line, for example, as shown in FIG. 13 a).

Additionally or alternatively, slots may be produced vertically in a strand or a layer or a ply ST and horizontally on an outer side of the strand ST, as shown in FIG. 13 b) and FIG. 14, in particular b) to e). In particular, it is thus possible to generate two narrow or thin structural parts or walls BWT which are connected by means of webs and which have a passage, in order for the intermediate space to later be filled with insulation material or to accommodate installation lines. In particular, the strand cross sections 4 of FIGS. 14 c), d) and e) may be arranged in particular in this sequence in and/or counter to the discharge direction x. In addition or alternatively, it is thus possible to produce open strand cross sections 4 in order to generate a media channel. In particular, the strand cross sections 4 of FIGS. 14 a), b), c) and d) may be arranged in particular in this sequence in and/or counter to the discharge direction x.

Further additionally or alternatively, a support structure such as a lattice may be arranged and/or is arranged on those strands ST which do not extend over the entire maximum opening width BO, in order to allow at least one further strand ST to be deposited. This can make it possible to prevent soft building material from sagging downward into the space, in particular hollow space.

Additionally or alternatively, a structural part can thus be produced with a decorative surface, as shown in FIG. 15.

Additionally or alternatively, a surface of a structural part or a wall BWT can thus have a QR code, as shown in FIG. 16. In particular, a strand ST can be roughened or made narrower for dark areas.

As the exemplary embodiments shown and discussed above make clear, the invention provides an advantageous extruder apparatus for the extrusion of a strand of building material for 3D printing of a structural part, which extruder apparatus has improved characteristics, in particular allows more degrees of freedom. The invention furthermore provides an extruder system having such an extruder apparatus, and the use of such an extruder apparatus and/or of such an extruder system.

1.-15. (canceled)

16. An extruder apparatus for extrusion of a strand of building material for 3D printing of a structural part, comprising:
an extruder nozzle, wherein the extruder nozzle has a discharge opening for discharge of the strand of building material out of the extruder apparatus; and
at least one cover element, wherein the at least one cover element is designed to cover at least a part of the discharge opening such that an opening cross section of at least one uncovered part of the discharge opening specifies a strand cross section of the discharged strand of building material.

17. The extruder apparatus as claimed in claim 16,
wherein the at least one cover element is designed to be variably settable for purposes of variably settably covering the discharge opening for purposes of variably setting the opening cross section for purposes of variably setting the strand cross section during the discharge of the strand of building material.

18. The extruder apparatus as claimed in claim 17,
wherein the at least one cover element is designed to be variably settable for purposes of separating off the discharged strand of building material from the extruder apparatus at the discharge opening.

19. The extruder apparatus as claimed in claim 16,
wherein the at least one cover element is designed for variably settable arrangement on the discharge opening so as to be in contact with the extruder nozzle.

20. The extruder apparatus as claimed in claim 16,
wherein the extruder nozzle specifies a discharge direction of the strand of building material out of the extruder apparatus, and
wherein the at least one cover element has at least one cover surface for partially covering the discharge opening, wherein the at least one cover surface is designed for non-parallel orientation with respect to the discharge direction.

21. The extruder apparatus as claimed in claim 16,
wherein the extruder nozzle has multiple peripheral walls,
wherein the multiple peripheral walls peripherally define the discharge opening, and at least two of the peripheral walls are designed to be variably settable for purposes of variable arrangement with respect to one another for purposes of variably setting the discharge opening during the discharge of the strand of building material.

22. The extruder apparatus as claimed in claim 16, wherein at least one of:
the extruder nozzle has at least one peripheral wall, wherein an extent of the extruder apparatus in a vertical direction is defined by the peripheral wall and wherein the discharge opening is peripherally partially defined by the peripheral wall,
an extent of the extruder apparatus in a horizontal direction is defined by the at least one cover element, or
the extruder apparatus has a deflecting device, wherein the deflecting device is arranged upstream of the discharge opening and is designed to deflect a flow of building material in the direction of the discharge opening.

23. The extruder apparatus as claimed in claim 16,
wherein the at least one cover element is designed to cover the at least one part of the discharge opening such that the opening cross section is at least divided into two parts with an interruption in a horizontal direction.

24. An extruder system for extrusion of a strand of building material for 3D printing of a structural part, comprising:
an extruder apparatus as claimed in claim 16; and
a controllable movement apparatus, wherein the movement apparatus is designed to at least translationally move the extruder apparatus during the discharge of the strand of building material.

25. The extruder system as claimed in claim 24,
wherein the movement apparatus is designed to move the extruder apparatus in a horizontal movement direction, and wherein the extruder apparatus is designed to discharge the strand of building material out of the extruder apparatus in a discharge direction, which is non-orthogonal with respect to the movement direction, during the movement, and/or
wherein the extruder system is designed for the discharge of the strand of building material out of the extruder apparatus with a variably settable discharge speed, and wherein the movement apparatus is designed to move the extruder apparatus with a movement speed which is approximately equal to the discharge speed during the discharge.

26. The extruder system as claimed in claim 24, further comprising:
a controllable building material pump, wherein the building material pump is designed to convey building material out of the extruder apparatus.

27. The extruder system as claimed in claim 26, further comprising:
at least one controllable setting apparatus, wherein the at least one setting apparatus is designed for variably setting the at least one cover element and/or at least one peripheral wall.

28. The extruder system as claimed in claim 27, further comprising:
a controllable vibrating apparatus, wherein the vibrating apparatus is designed to vibrate the at least one cover element.

29. The extruder system as claimed in claim 28, further comprising:
a control device, wherein the control device is designed to automatically control the movement apparatus, the building material pump, the at least one setting apparatus, and/or the vibrating apparatus, in a manner dependent on data of the structural part to be printed.

30. The use of an extruder apparatus as claimed in claim 16 for the extrusion of a strand of building material for 3D printing of a structural part.
